(19) United States
(12) Patent Application Publication
(10) Pub. No.: US 2025/0212171 A1
(43) Pub. Date: Jun. 26, 2025

(54) METHOD TO INCREASE A NAVIGATION UPDATE RATE FOR A RTK POSITIONING SYSTEM

(71) Applicant: VIETTEL GROUP, Ha Noi City (VN)

(72) Inventors: QUANG DAN CHU, Dien Chau District (VN); NGOC KHIEM TRAN, An Thi District (VN); PHUONG NAM LE, Ha Noi City (VN); THI HONG LINH PHAN, Ha Noi City (VN)

(73) Assignee: VIETTEL GROUP, Ha Noi City (VN)

(21) Appl. No.: 18/924,861

(22) Filed: Oct. 23, 2024

(30) Foreign Application Priority Data
Dec. 26, 2023 (VN) 1-2023-09262

(51) Int. Cl. H04W 64/00; G01S 11/02; G01S 19/48; H04L 5/14

(52) U.S. Cl. CPC H04W 64/006; G01S 11/02; G01S 19/48; H04L 5/14

(57) ABSTRACT

The invention addresses a method for simultaneously retrieving NTRIP data streams and transmitting positioning data using a 4G network for low-cost RTK positioning systems. This method employs the PPPoS protocol and the LwIP library, along with the implementation process of applying this method to real-world systems. The approach enhances data update rate and ensures high accuracy with a superior RTK “Fixed” positioning rate for affordable RTK systems, significantly optimizing hardware system costs. The effectiveness of the invention has been demonstrated through practical testing, showing a marked improvement and complete resolution of the limitations associated with the previous AT command method.

### TECHNICAL AREAS MENTIONED

The invention covers an approach of increasing navigation update rate for low-cost positioning systems with centimeter-level accuracy using Real Time Kinematics (RTK) positioning technology. Specifically, the patent can be applied to a number of fields that require high-precision, cost-effective location positioning such as precision agriculture, self-driving vehicles, autonomous flying objects, cadastral surveying, and border guard, seaport, airport.

### The Technical Status

The high-precision and real-time positioning are essential requirements in some fleet management applications serving outdoor transportation of people and cargo such as seaports and airports; precision agriculture; or geographic coordinates monitoring applications for cadastral surveying, border guard. Most of these applications require extremely high accuracy level of locating coordinates, normally centimeter-level accuracy, and the ability to real-time navigation updating. However, for conventional positioning systems using traditional Global Navigation Satellite System (GNSS), the achieved accuracy is quite low (<10 m) depending on the certain conditions. Hence, it is basically impossible to meet the requirements.

Currently, the RTK technology (Real Time Kinematics) allows positioning to achieve the highest accuracy of the centimeter level with a fast convergence time from 10 to 60 seconds. This approach can be applied for applications with the distances between Rovers and Base Stations less than 20 kilometers. Therefore, the navigation approach using RTK technology would be suitable for applications that require high accuracy, small outdoor operating area and real-time navigation update.

RTK technology works based on Double Difference GNSS positioning techniques to eliminate errors associated with the technique of determining distance based on carrier phase measurements (Carrier-based ranging) instead of based on PRN code and navigation message (Code-based ranging) like traditional GNSS. The distance between the satellite and the receiver is determined based on the integer number of carrier wavelengths transmitted from the satellite to the receiver through the process of integer ambiguity resolution. To implement this technique, the GNSS receiver needs data sources according to the standard of the Radio Technical Commission for Maritime Services (RTCM) from a reference station with aware coordinates to perform the correction. Some prevalent wireless backhaul technology for data exchange between rovers and the reference stations can be mentioned like short-range radio wave Bluetooth, long-range radio wave LoRa (Long Range), and broadband 4G/LTE cellular network. Among them, the widespead technology is 4G/LTE cellular network due to its high bandwidth, good scalability, and convinient deployment using the Network Transport of RTCM via Internet Protocol (NTRIP).

For RTK navigation systems owning large budget for the devices, the main processor of the device normally supports running on operating system (OS) for powerful processing capacity and high navigation update rate, PVT (Position, Velocity, Time) of 20 Hz. However, the drawbacks of these systems are high cost (thousands of USD) and high energy consumption. This characteristic makes these systems unsuitable for low-cost and energy-saving applications such as those mentioned above.

For low-cost systems, the main processor of the device is normally a microcontroller responsibled for processing and communicating with the GNSS RTK module and 4G mobile network module via the Universal Asynchronous Receiver/Transmitte (UART) standard, described in FIG. 1. This system has the advantages of low cost, easy to design, and low energy consumption. However, its drawbacks are limited processing power, low navigation update rate (0.06-1 Hz or equivalent to interval of 10-15 second). This limitation is derived from using AT commands set for communicating between the microcontroller and the 4G/LTE network module via UART standard, which causes interruption of the stream to pull NTRIP data over HTTP (Hyper Text Transfer Protocol) while sending the location message to the server. Meanwhile, the RTK positioning technique requires maintaining a continuous NTRIP data stream to retrieve correction data according to RTCM standards throughout the operation to resolve integer ambiguity of the carrier. The interruption will cause the device to lose the highest accuracy positioning state “Fixed” down to the lower accuracy state “Float”, or even to “DGNSS” state. Restoring to the “Fixed” state normally takes at least 10 seconds. Therefore, the navigation update rate to the server is limited, hence not meeting some applications that require high navigation update rate.

Consequently, the authors propose a methodology to enhance RTK navigation update rate for low-cost and energy-saving RTK systems by utilizing the PPPoS (Point to Point Protocol over Serial) protocol in conjunction with the LwIP (Lightweight IP) library. This approach facilitates the simultaneous retrieval of the NTRIP data stream and transmission of intended data to the server using a single 4G network module, without disrupting the NTRIP data flow. Additionally, the authors introduce a flowchart for the CNUS (Correct and Navigation Update Simultaneously) program, which enables the application of this method on widely-used hardware platforms.

### The Technical Nature of the Disclosure

This invention introduces a method that combines the PPPoS protocol and the LwIP library to enable simultaneous transmitting and receiving data between the microcontroller and a 4G mobile network module. This approach significantly enhances the navigation update rate to server for low-cost, high-precision positioning systems. The authors further present a flowchart for the CNUS program, which implements the proposed method by segmenting the program into tasks managed by a Real-Time Operating System (RTOS). This management enables the concurrent pulling of correction data streams via the HTTP protocol and the reading, decoding, and transmission of location messages to the server using the MQTT (Message Queuing Telemetry Transport) protocol or any other TCP/IP (Transmission Control Protocol/Internet Protocol) protocol at the application layer. This methodology facilitates the continuous retrieval of RTCM correction data streams from an NTRIP station via the HTTP protocol while concurrently reading, decoding, and transmitting satellite messages compliant with National Marine Electronics Association (NMEA) data standards to the server over a single 4G network connection.

This method differs from the previous approach using AT commands in several key aspects as follows:
Using PPPoS protocol instead of using AT commands set, allows the microcontroller to communicate directly with the 4G module at the Data-Link layer thus enabling efficient data transmission/reception capabilities more effective.
RTCM correction data from the NTRIP server is pulled via the HTTP protocol and transmitted directly through the microcontroller, where it is decoded and sent to the GNSS RTK module via the UART interface for correction.
The microcontroller packages messages according to the MQTT or HTTP protocol at the application layer, then transmits them to the pre-configured 4G module, which remains in data mode, ready to send the data to the server.

The process of implementing the RTK positioning system, which applies the method of simultaneously pulling NTRIP data streams and sending positioning data using the 4G network, includes the following main steps: setting up the UART transmission channel, setting up data mode and PPPoS, initiating tasks, and executing tasks:
Set up UART transmission channel: initiate and configure the parameters of two UART sets for two communication channels between the microcontroller with the 4G network module and GNSS RTK module.
Set up data mode PPPoS: perform the necessary steps to boot and initialize the 4G module, and transition the module from AT commands mode to data mode PPPoS on the pre-configured UART transmission channel.
Initiate tasks: declare resources and initiate the main tasks, which include pulling the NTRIP data stream and sending messages to the server, all managed by the RTOS operating system.
Execute tasks: run the processes within the main tasks that were previously declared and initiated, ensuring the smooth operation of the system

### BRIEF DESCRIPTION OF THE DRAWINGS

FIG. 1 depicts a low-cost RTK positioning hardware system using the AT commands set method;

FIG. 2 depicts the process of implementing the RTK positioning system applying the method of pulling NTRIP data streams and sending positioning data simultaneously;

FIG. 3 depicts the process of initializing and setting up data communication mode based on the PPPoS protocol between the microcontroller and the 4G network module;

FIG. 4 depicts the flow chart of the main tasks and main processes in the tasks of the method in the invention;

FIG. 5 depicts a low-cost RTK positioning hardware system using PPPoS protocol and LwIP library;

FIG. 6 is a diagram of the UART communication channel connection between the microcontroller, 4G module and GNSS RTK module; and

FIG. 7 is an illustration of marked locations based on data obtained from the Google map satellite server in a field test.

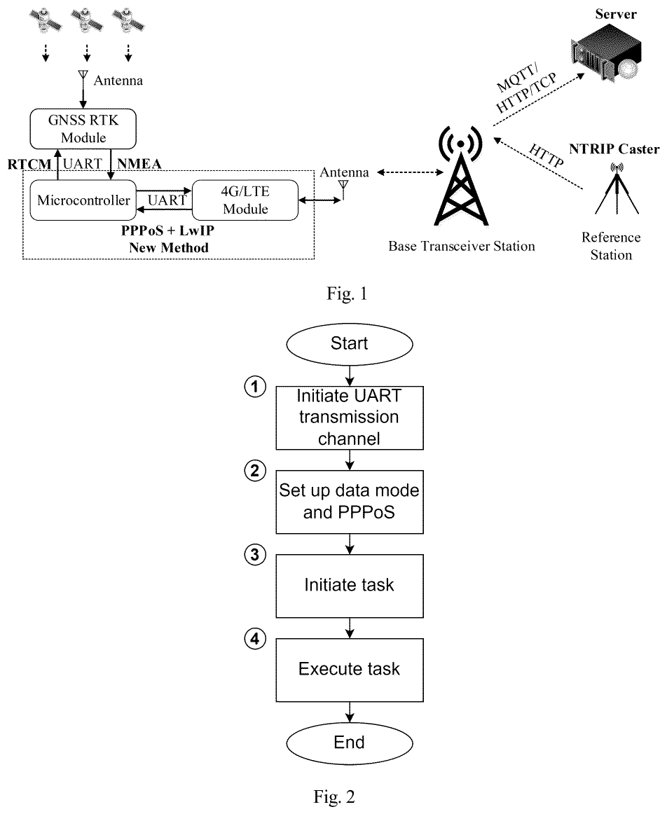

### DETAILED DESCRIPTION

The invention, as succinctly outlined in the preceding section, will concentrate on enhancing the navigation update rate of a cost-effective RTK GNSS positioning system by modifying the communication protocol between the microcontroller and the 4G network module. Specifically, it involves transitioning from the use of AT command sets to the PPPoS protocol, in conjunction with the LwIP library, all implemented within an RTOS environment.

The proposed method comprises four primary steps, as illustrated in the flowchart in FIG. 2. The details of these steps are as follows:
Step 1: initiate UART transmission channel;

The system uses a microcontroller as the central processing unit (can be ARM or RISCV architecture), performing the following main tasks:
Communicate with the 4G network module via UART communication to perform the task of pulling the Ntrip data stream using HTTP protocol;
Send RTCM format Ntrip data to RTK module via UART communication;
Receive and decode GNSS data in NMEA format from the RTK module through UART communication;
Package the data message in MQTT format and send it to the server.

The communication channel between the microcontroller and both the 4G module and RTK module is UART with dedicated hardware on the microcontroller, enabling full-duplex transmission and reception. Prior to transmitting or receiving data, configuration parameters such as the transmission pin, clock, interrupt service, baud rate, parity bit (even/odd), number of data bits, and stop bit must be declared.
Step 2: set up data mode and PPPoS;

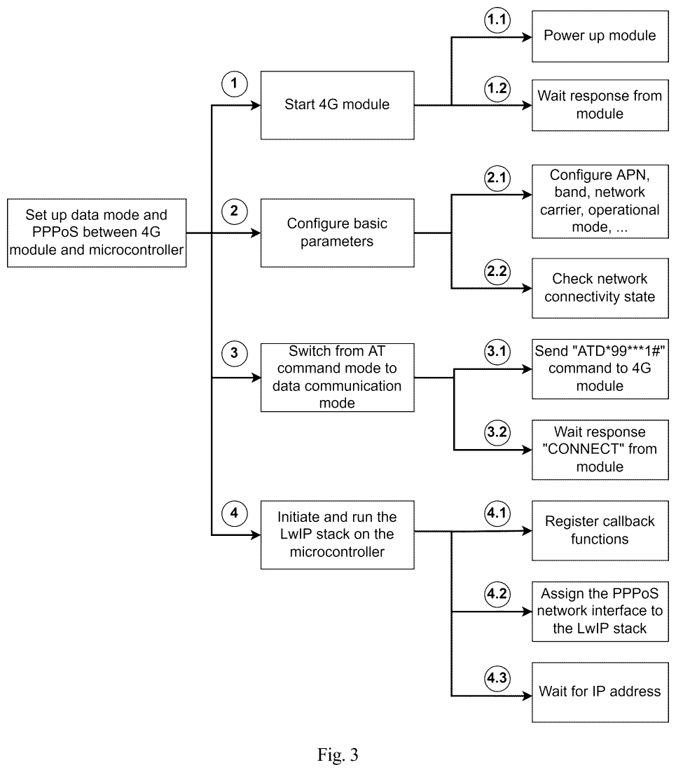

The procedure for initializing and establishing a data communication mode based on the PPPoS protocol between the microcontroller and the 4G network module is depicted in FIG. 3 and includes the following steps:
Starting the 4G module: the 4G module is powered on by pulling its power pin (Powerkey) to ground for a specific duration, typically around 200 ms. Subsequently, the microcontroller repeatedly sends “AT” commands (approximately every 1 second) until it receives an “OK” response from the module, indicating successful startup.
Configure basic parameters: this step involves configuring essential parameters, including the APN (Access Point Name), network carrier, and frequency bands (e.g., B1, B3, B8 for the 4G network in Vietnam). Additional configurations include operating mode, SIM card status, subscription details via IMSI (International Mobile Subscriber Identity) and ICCID (Integrated Circuit Card ID), and other parameters based on the specific 4G module. The signal strength and network registration status are also verified. After completing these configurations, the module is ready to connect to the network.
Switch from AT command mode to data communication mode: the microcontroller sends the “ATD99**1 #” command to the 4G module and waits for a “CONNECT” response, which indicates that the module has successfully transitioned to data communication mode.
Initiate and run the LwIP stack on the microcontroller: the microcontroller registers callback functions to monitor network connection statuses (e.g., start, end, connection established, connection lost). It then assigns the PPPoS network interface to the LwIP stack (a TCP/IP based protocol) and initiates the stack. The system then waits for an IP address assignment. The receipt of an IP address confirms that the PPPoS data mode between the microcontroller and the 4G module has been successfully established, enabling data transmission and reception over the 4G network.
Step 3: initiate tasks;

Aligned with the objectives of the proposed method and tailored for hardware platforms with limited performance, such as microcontrollers, the authors have considered that a real-time operating system (RTOS) is well-suited for managing and executing the program by dividing it into tasks. The operational program of the system can be segmented into two primary tasks for the microcontroller: one task is responsible for retrieving NTRIP data, while the other is focused on transmitting messages to the server. These tasks must be executed concurrently, rather than sequentially. Prior to running these tasks, it is essential to declare, configure, and initialize the task parameters, including key parameters such as stack memory, priority levels, and available cores (for multi-core microcontrollers).
Step 4: execute tasks;

The final step of the method is to execute the tasks that have been initiated to complete a full program. The program running on the RTOS manages microcontroller resources and handles two tasks: retrieving NTRIP data and sending data to the server. These tasks are assigned equal priority and are managed by the RTOS using Round-Robin Scheduling. Each task will execute a specific sequence of processes, which will be detailed in the following section.

By following the steps outlined in the proposed method, the program running on the microcontroller will ensure that location data is updated to the data server with an improved rate of at least 1 Hz (1 message per second), without interrupting the continuous flow of NTRIP data retrieval and transmission to the RTK module via a single 4G module. The effectiveness of this method will be evaluated through the positioning-mode distribution ratio, which will be presented in the actual testing section of the device that implements the proposed method of the invention.

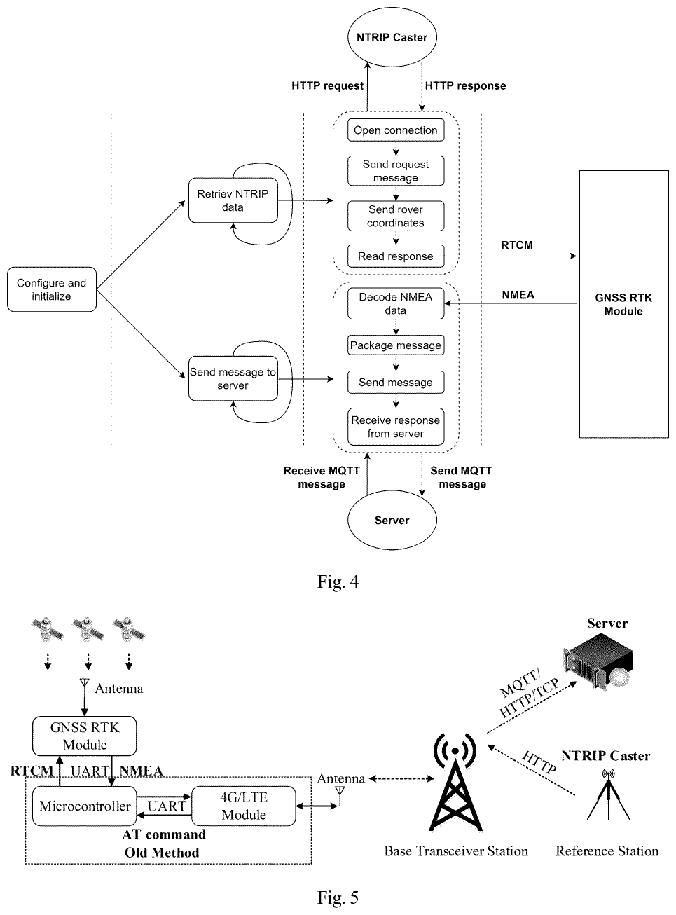

To practically implement this method, the authors developed a flowchart of the CNUS program, enabling the proposed method to be implemented on most common low-cost hardware platforms. FIG. 4 illustrates the main tasks and processes that need to be executed within RTOS. Each task comprises essential processes that are performed sequentially, and these tasks are initiated, scheduled, and controlled through the RTOS.

Task of retrieving NTRIP data: main processes to perform include:
Check DNS resolution and open HTTP connection port: this process includes resolving the DNS (Domain Name System) to obtain the IP address and establishing the necessary HTTP connection ports by creating and connecting to them.
Package and send the HTTP request: formulate and send an HTTP request that includes essential details such as the server address (domain name or IP), port number, path, and authentication credentials. The authentication code is generated by encrypting the user account's ID and password (registered with the NTRIP service provider) using the “Base64” encryption standard. The authentication method employed is the basic form.
Send rover coordinates: transmit the coordinates of the rovers to the NTRIP Server in NMEA format, typically using the GNGGA message format. This step is crucial because the NTRIP service server only returns data after receiving the coordinates of the rovers.
Read and process HTTP response: continuously read the HTTP response from the NTRIP service server in each data segment. The received data is then forwarded to the RTK module via UART. This process is repeated until there is no more response data, at which point the entire operation is reiterated.

Task of sending message to the server: processes that need to be performed include:
Decode GNSS data: read and decode NMEA format messages received from the RTK module via UART communication.
Package messages: organize the decoded coordinate data and any other relevant information into a message format suitable for transmission.
Send messages: use the LwIP library to establish a connection with the MQTT Broker. Register to receive data on a designated response channel and transmit the data to the specified channel (topic).
Receive response from the server: if there is any configuration or response from the server via the registered channel, the microcontroller can receive it and reconfigure the device according to the settings of server.

The detailed methods and flowcharts of the CNUS program outlined above enable the simultaneous retrieval of NTRIP data streams and the transmission of positioning data using the 4G network. The aim is to enhance the data update rate for high-accuracy positioning systems at a low cost using RTK positioning technology. The following section will describe a specific system implementation that applies the method discussed in the disclosure.

### Invention Execution Example

An example model suitable for a low-cost, real-time, and high-accuracy positioning system is illustrated in FIG. 5. This model demonstrates the method of simultaneously retrieving NTRIP data streams and transmitting positioning data using the 4G network, applied to a cost-effective RTK positioning system. The authors have implemented this approach in a low-cost system with the main hardware configuration detailed in Table 1, achieving a total cost of less than 300 USD.

TABLE 1
System hardware configuration applying
the method in the invention

| No | Components | Model | Specifications |
|---|---|---|---|
| 1 | Module GNSS RTK | ZED_F9P | Band: L1/L2/L5 |
| | | (uBlox) | Satellite: GPS + |
| | | | QZSS/SBAS, Glonass, |
| | | | Galileo, Beidou |
| | | | RTK horizontal accuracy |
| | | | (CEP): 0.01 m + 1 ppm |
| | | | RTK convergence time: <10 |
| | | | seconds |
| | | | RTK max navigation |
| | | | update rate: 20 Hz |
| 2 | Module 4G/LTE | A7682E | LTE Cat 1 |
| | | (Simcom) | Band: |
| | | | B1/B3/B5/B7/B8/B20 |
| | | | Data rate: UL 5 Mbps, DL |
| | | | 10 Mbps |
| 3 | Microcontroller | ESP32-S3 | 2.4 GHz Wifi and |
| | | (Espressif) | Bluetooth 5 (LE) |
| | | | SRAM: 512 kB |
| | | | Clock: 240 MHz |
| 4 | Antenna | AN-608 | Gain: 36 dB |
| | | (TOPGNSS) | Band: GNSS L1/L2 |
| | | | Satellite: GPS, Glonass, |
| | | | Beidou, Galileo |
| | | | Water proof: IP67 |

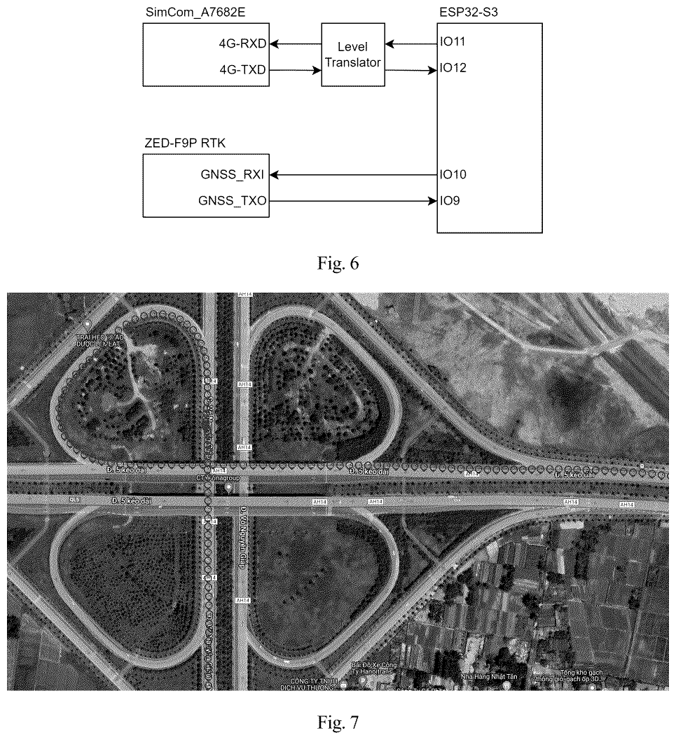

The pin connection diagram of the communication ports between the three main components of the system is depicted in FIG. 6.

The basic software specifications are shown in Table 2.

TABLE 2
Software specifications

| No | Specifications | Value | |
|---|---|---|---|
| 1 | All UART communication | Hardware UART, | |
| | lines | baudrate: 115200, | |
| | | 8-bit data, 1 stop | |
| | | bit, 0 even/odd bit | |
| 2 | Data buffer NTRIP | 2048 | bytes |
| 3 | Data buffer NMEA | 1024 | bytes |
| 4 | RTOS task configuration | Stack size: 8192 byte, | |
| | | priority level: 5 | |
| 5 | HTTP configuration | Web_server: “vngeonet.vn”, | |
| | | web_port: 2103, mountpoint: | |
| | | “SB.105M6” | |
| 6 | Format of location message | NMEA GNGGA | |
| | sent to NTRIP Caster | | |
| 7 | NMEA output update rate | 1 | Hz |
| 8 | RTL data to server update | 1 | Hz |

| | | |
|---|---|---|
| | rate | |
| 9 | LwIP library version | 2.1.2 |
| 10 | NTRIP message format | RTCM3 |

To evaluate the effectiveness of the new method using the PPPoS protocol and the LwIP library, the authors also implemented the previous method using AT commands on the same hardware system. For comparison, two data update rates were selected for the AT command method: 15 seconds per message (interval of 15 seconds) and 30 seconds per message (interval of 30 seconds). This comparison aimed to assess the actual convergence time of the RTK module.

The effectiveness of the methods was evaluated based on positioning state distribution of the device. The test was conducted in a well-ventilated area with minimal obstructions such as buildings and trees, avoiding areas with poor mobile signal reception, specifically in the Nhat Tan-Tay Ho-Hanoi bridge area, to ensure the reliability of the proposed method.

A total of 7200 location data samples were collected across all three test scenarios, all performed in the same area. The results are summarized in Table 3.

TABLE 3
Results comparing the performance of the proposed methods and the
old method through the distribution of positioning state rates

| | Percentage | Percentage | Percentage | Percentage |
|---|---|---|---|---|
| | of RTK “Fixed” | of RTK “Float” | of “DGNSS” | of “GNSS” |
| Method | state | state | state | state |
| Method | 97.7% | 2.1% | 0.2% | 0% |
| PPPoS + LwIP | | | | |
| with interval of 1 | | | | |
| second | | | | |
| Method commands | 70.5% | 15.6% | 12.9% | 1.0% |
| AT | | | | |
| with interval of 15 | | | | |
| seconds | | | | |
| Methodcommands | 94.3% | 4.5% | 1.1% | 0.1% |
| AT | | | | |
| with interval of 30 | | | | |
| seconds | | | | |

The positioning states are RTK “Fixed” (4)—represents the highest precision positioning state indicating successful resolving of wavelength integer ambiguity and achieving the maximum accuracy, RTK “Float” (5)—a positioning state where the integer number of wavelengths cannot be resolved, DGNSS (2)—differential GNSS positioning state, GNSS (1)—single GNSS positioning state.

When a device attains RTK “Fixed” positioning state, it signifies that the algorithm for resolving wavelength integer ambiguity has been effectively applied, providing the highest level of accuracy. FIG. 7 depicts the locations marked based on data retrieved from the Google Maps satellite server during the actual test.

The results indicate that the method utilizing PPPoS combined with the LwIP library, as proposed by the authors, achieves a data update rate of 1 Hz (1 message per second), with an RTK “Fixed” positioning rate reaching 97.7%. This rate is significantly higher compared to the old method using AT commands, which achieved rates of 70.5% and 94.3% under similar conditions. In the AT command method, interruptions in the RTCM data stream while sending location data messages to the server caused delays in resolving wavelength integer ambiguity. Consequently, the RTK module required more time to converge than the ideal module parameters of less than 10 seconds. This explains the phenomenon that update interval of 30 seconds achieved a higher RTK “Fixed” rate (94.3%) compared to a update interval of 15 seconds (70.5%) with the same AT command method, as the longer interval allowed additional time for receiving RTCM data and processing the RTK algorithm.

Overall, the findings demonstrate that the PPPoS protocol combined with the LwIP library, as proposed in the patent, significantly enhances the navigation update rate and improves the RTK “Fixed” positioning rate compared to the traditional AT command method.

### Effectiveness of the Invention

The method employing the PPPoS protocol combined with the LwIP library for simultaneously retrieving NTRIP data streams and transmitting data over 4G mobile networks is highly effective for low-cost, high-precision RTK positioning systems. This approach offers excellent performance and is easily applicable to a range of popular, cost-effective hardware platforms. It addresses the issue of slow data update rate associated with the traditional AT commands method. The practical application of this method has demonstrated a significant improvement in navigation update rate, reducing it from 10 seconds per message to 1 second per message, and enhancing the rate of achieving RTK “Fixed” positioning. This advancement helps optimize hardware system costs while maintaining reliable device performance.

1. A method to increase a navigation update rate for a RTK positioning system involves the following steps:
step 1: initiate UART transmission channel;
the system utilizes a microcontroller (which may be based on ARM or RISC-V architecture) as a central processing unit to perform the following tasks:
communicate with a 4G network module via UART to retrieve an NTRIP data stream using the HTTP protocol;
send RTCM format Ntrip data to RTK module via UART communication;
receive and decode NMEA format GNSS data from RTK module via UART communication;
package a data message in MQTT format and send it to a server;
communication between the microcontroller and both the 4G network module and the RTK module is conducted over UART, specialized hardware of the microcontroller facilitates duplex transmission and reception, prior to data transmission or reception, configurations must be declared, including transmission pin, clock settings, interrupt service routines, baud rate, parity (even/odd), number of data bits, and stop bits;
step 2: set up data mode and PPPoS;
a procedure for initializing and establishing data communication mode based on the PPPoS protocol between the microcontroller and the 4G network module includes:
start the 4G network module: initiate the 4G network module by grounding a Powerkey pin for approximately 200 ms, the microcontroller will then send “AT” commands at intervals of about 1 second until receiving an “OK” response from the module, indicating successful startup;
configure basic parameters: set up an APN (Access Point Name), network carrier, band configuration (e.g., B1, B3, B8 for 4G networks in Vietnam), operating mode, and check SIM reception status, additionally, configure subscription parameters such as IMSI (Internal Mobile Subscriber Identity) and ICCID (Integrated Circuit Card ID), among others specific to the 4G network module, verify a mobile signal status and registration with a core network, after these configurations, the 4G network module should be able to connect to the network;
switch from AT Command Mode to Data Communication Mode: Send a command “ATD99**1 #” to the 4G network module and wait for a “CONNECT” response, upon receiving this response, the 4G network module will have successfully switched to data communication mode;
initiate and Run a LwIP Stack on the Microcontroller: Register functions that return network connection statuses (e.g., start, end, connected, lost connection), assign a PPPoS network interface to the LwIP stack (TCP/IP protocol platform), and initiate the process, wait for an IP address response, the receipt of an IP address confirms that a PPPoS data mode between the microcontroller and the 4G network module has been successfully established, enabling data transmission and reception over the 4G network;
step 3: initiate tasks;
an operating program on the microcontroller is divided into two primary tasks: retrieving NTRIP data and sending messages to the server. these tasks must be executed concurrently (not sequentially, before task execution, it is necessary to declare, configure, and initialize task parameters, including stack memory, priority levels, and core allocation (for multi-core microcontrollers);
step 4: execute tasks;
the program runs on an RTOS (Real-Time Operating System) that manages microcontroller resources, executing and managing the two tasks: retrieving NTRIP data and sending data to the server, these tasks are assigned equal priority and are managed by the RTOS using Round-Robin Scheduling, each task must execute a series of sequential processes, which will be described in detail in the subsequent section.
